(19) United States
(12) Patent Application Publication
(10) Pub. No.: US 2024/0007865 A1
(43) Pub. Date: Jan. 4, 2024

(54) Methods and Apparatus for Peer Network Communication in Wireless Networks

(71) Applicant: Celona, Inc., Campbell, CA (US)

(72) Inventors: Srinivasan Balasubramanian, SanDiego, CA (US); Sourav Bandyopadhyay, Liluah Howrah (IN)

(21) Appl. No.: 18/342,133

(22) Filed: Jun. 27, 2023

Related U.S. Application Data
(60) Provisional application No. 63/357,565, filed on Jun. 30, 2022.

(51) Int. Cl. H04W 16/14

(52) U.S. Cl. CPC H04W 16/14; H04W 84/04

(57) ABSTRACT

Various embodiments of methods and apparatus for peer network communication in wireless networks are disclosed. The methods and apparatus make use of a local region or coordination zone that supports a set of Enterprise deployments each including a group of CBSDs that taken together comprise a set of interacting nodes. The group of deployments in a local region are willing to coordinate activities with each other to establish a mutually aggregable set of operating parameters for each of their networks. These entities share information that enables distributed computation and the sharing of results to agree on mutually acceptable network operating parameters.

### INCORPORATION BY REFERENCE

This non-provisional application claims priority to an earlier-filed provisional application No. 63/357,565 filed Jun. 30, 2022, entitled “Methods and Apparatus for Peer Network Communication in Wireless Networks” (ATTY DOCKET NO. CEL-071-PROV) and the provisional application No. 63/357,565 filed Jun. 30, 2022, and all its contents, are hereby incorporated by reference herein as if set forth in full.

### (1) TECHNICAL FIELD

The disclosed method and apparatus generally relate to methods and apparatus for coordinating information between wireless networks that may, in some cases, be adjacent to each other. In particular, the disclosed method and apparatus relate to peer network communication between wireless networks.

### (2) BACKGROUND

The wireless industry has experienced tremendous growth in recent years. Wireless technology is rapidly improving, and faster and more numerous broadband communication networks have been installed around the globe. These networks have now become key components of a worldwide communication system that connects people and businesses at speeds and on a scale unimaginable just a couple of decades ago. The rapid growth of wireless communication is a result of increasing demand for more bandwidth and services. This rapid growth is in many ways supported by standards. For example, 4G LTE has been widely deployed over the past years, and the next generation system, 5G NR (New Radio) is now being deployed. In these wireless systems, multiple mobile devices are served voice services, data services, and many other services over wireless connections so they may remain mobile while still connected.

It is commonplace today for communications to occur over a wireless network in which user equipment (UE) connects to the network via a wireless transceiver, such an eNodeB, gNodeB, access point or base station, hereafter referred to generically as a BS/AP (base station/Access Point). In this disclosure the term eNodeB is shortened to the term “eNB” or “gNB” and is used generically to refer to the following: a single sector eNB/gNB; a dual sector eNB/gNB, with each sector acting independently; and a node that supports both eNB and gNB functions. The UE may be a wireless cellular telephone, tablet, computer, Internet-of-Things (IoT) device, or other such wireless equipment. The BS/AP may be an eNodeB (“eNB”) as defined in 3GPP specifications for long term evolution (LTE) systems (sometimes referred to as 4^{th} Generation (4G) systems) or a gNodeB as defined in 3GPP specifications for new radio (NR) systems (sometimes referred to as 5G systems). Furthermore, the BS/AP may be a single sector node or a dual sector node in which each of two sectors act independently. In 4G and 5G systems, there are times when a relatively large number of UEs may be attempting to access the network through the same “cell”.

In many cases, there is a mix of UEs, some requiring high throughput with data arriving in bursts and other UEs requiring minimal throughput, but having frequent data transmit and receive requirements. The term ‘BS/AP” is used broadly herein to include base stations and access points, including at least an evolved NodeB (eNB) of an LTE network or gNodeB (gNB) of a 5G network, a cellular base station (BS), a Citizens Broadband Radio Service Device (CBSD) (which may be an LTE or 5G device), a Wi-Fi access node, a Local Area Network (LAN) access point, a Wide Area Network (WAN) access point, and should also be understood to include other network receiving hubs that provide access to a network of a plurality of wireless transceivers within range of the BS/AP. Typically, the BS/APs are used as transceiver hubs, whereas the UEs are used for point-to-point communication and are not used as hubs. Therefore, the BS/APs transmit at a relatively higher power than the UEs.

FIG. 1 is an illustration of a basic configuration for a wireless communication network, such as a “4G LTE” (fourth generation Long-Term Evolution) or “5G NR” (fifth generation New Radio) network, and exemplary components of the wireless communications network 100. In some embodiments, the communications network 100 comprises a Radio Access Network (RAN). It is commonplace today for communications to occur over a wireless network in which user equipment (UE) (such as, for example, UEs 101a, 101b, 101c, and 101d) connect to the network 100 via a wireless transceiver, such as an eNodeB (eNB), gNodeB (gNB), Access Point (or base station) 103, hereafter referred to generically as a BS/AP (base station/Access Point) or more simply, an Access Point (AP) 103. A wireless device operated by a user, commonly referred to as a “User Equipment” (UE), is typically in wireless communication with the Access Point (AP) 103, or, more specifically, via a base station antenna 109. Although only a single AP 103 is shown in FIG. 1, typically several APs 103 are used to communicate with the plurality of UEs in typical communication network 100 deployments.

The term UE refers to a wide array of devices having wireless connectivity, such as a cellular mobile phone, Internet of Things (IoT) devices, virtual reality, robotic device, autonomous driving machines, smart barcode scanners, and communications equipment, which includes cell phones, desktop computers, laptop computers, tablets and other types of personal communications devices. Throughout this disclosure, the term BS/AP is used broadly to include at least an extended NodeB (eNB) or gNB of an LTE/5G network, a cellular base station (BS), a Citizens Broadband Radio Service Device (CBSD), a WiFi access node, a Local Area Network (LAN) access point, a Wide Area Network (WAN) access point, etc. and should also be understood to include other network receiving hubs that provide wireless access by a plurality of wireless transceivers to a network.

In some cases, a UE 101 uses a BS/AP 103 to gain access to a network of other devices and services. 5G technology supports both public networks and private networks, such as cellular networks and Enterprise networks. The BS/AP 103 is coupled to a core network 114 that provides management and connectivity to resources, such as the internet 107.

FIG. 2 is an illustration of a larger network 260, such as a 5G cellular network operated by a Mobile Network Operator (MNO), sometimes referred to as a wireless service provider. Within the geographic operating area of the MNO network, a private network may be established by a private network operator, such as an enterprise network operator (ENO). Private networks are operated for use by a limited group of authorized users, whereas public networks are open for use by anyone that subscribes to the service by the network operator. An Enterprise network is one particular type of private network operated by an organization for use by the members of the organization. Other types of private networks may be operated by a private network manager for use by more than one organization. As shown in FIG. 2, BS/APs 103a of the MNO network may service a plurality of UEs (101 in FIG. 1, 102 in FIG. 2) that are present within the footprint of the MNO network 204 on a first frequency f1. In addition, if a private network 208 is operated within the geographic footprint of the MNO network 204, one or more EN BS/APs 103b may provide connectivity for the UEs 102b that are present within the footprint of the private network 208 on a second frequency f2.

Recently, the US Federal Government finalized rules for the use of an area of the frequency spectrum referred to as the Citizens Broadband Radio Service (CBRS). CBRS operates in a 150 MHz wide frequency range from 3.55 GHz to 3.7 GHz. In many cases, private networks are being established in accordance with 5G specifications using CBRS bands.

In cellular communication systems, such as 4G LTE and 5G NR networks, the BS/APs 103 operated by each MNO transmit a unique identifier as part of their wireless transmission. This unique identifier is called a Cell Identifier (ID). The Cell ID identifies the BS/AP 103 transmitting the Cell ID and thus provides a means for identifying the cell providing the cellular communications service for the geographic area.

### CBRS Networks

Another type of wireless networks that recently became available for general use by enterprises at their enterprise locations is a Citizen's Broadband Radio Service (CBRS), also referred to herein as Citizen Band Radio Service (CBRS) networks. These CBRS networks utilize the CBRS radio band of 3550-3700 MHz (which is 150 MHz of CBRS frequency spectrum), nominally divided into fifteen frequency channels of 10 MHz each. Particularly, the FCC recently approved use of the CBRS Radio band of the frequency spectrum and finalized rules (Rule 96) that allow general access to the CBRS Radio band. The CBRS rules set forth therein detail requirements for the devices that operate in a CBRS network and dictate how they communicate with each other. CBRS supports both LTE and 5G devices.

FIG. 3 is a diagram of a wireless communication network that may be implemented as an Enterprise Network 250 using a CBRS network. A plurality of BS/APs 202a, 202b, 202c, and 202d are deployed in an enterprise location 200. It should be noted that throughout this disclosure, a reference string (such as “202a”) used to identify a feature in a figure, having a string of numeric characters followed by one or more alphabetic characters, identifies a feature of the figure that is similar to other features in the figures having the same numeric string of characters. For example, the BS/AP 202a is similar in terms of functionality and performance to the BS/AP 202b, 202c and 202d. Furthermore, a reference string having only the numeric string (i.e., lacking the alphabetic characters) refers collectively to all of the features having the same numeric string. For example, the BS/AP 202 refers collectively to all four of the BS/APs 202a, 202b, 202c and 202d.

In FIG. 3, each BS/AP 202 has a range, defining a wireless coverage area or “Radio Footprint”. The BS/APs 202 may comprise CBSDs in a CBRS system. A first UE 201a is wirelessly connected to a first BS/AP 202a, which is providing service to it. A second UE 201b is wirelessly connected to a second BS/AP 202b, and is providing service to the second UE 201b. Other UEs 201, which connect wirelessly to the BS/APs 202, are shown in the enterprise location 200. All of the BS/APs 202 are connected to a PDN 220 by any appropriate communication means, such as wire, fiber optic, and wireless radio. The PDN 220 provides a connection to an operator network 222 that includes an Oracle (OAM) Server 207, a SON assist unit 208, a Domain Proxy 209, an Automatic Configuration Server (ACS) 210 and a Location Database 211, all of which are connected to each other within the operator network 222 by any appropriate communication means. An MNO network may be connected to a Spectrum Access System (SAS) 212, which is connected to a Spectrum Database 213 that includes data regarding the CBRS spectrum that the SAS 212 manages. Collectively, the SAS 212 and the Spectrum Database 213 are referred to as a Spectrum Management Entity (SME) 214. As is well known, the SAS 212 is typically a cloud-based service that manages the wireless communications of devices transmitting in the CBRS band, in order to prevent harmful interference to higher priority CBRS users. A CBRS device (CBSD) needs authorization from the SAS 212 before it begins transmissions in the CBRS band.

In some of the literature, the BS/APs 202 within a CBRS network are termed “CBSDs”, and the UEs 201 are termed End User Devices (EUDs).

The CBRS rules require that a SAS (such as the SAS 212 of FIG. 3) allocate spectrum to the CBSDs to avoid interference within the CBRS band. The SAS 212 is a service that manages the spectrum used in wireless communications of devices transmitting in the CBRS band in order to prevent harmful interference to higher priority users such as the military and priority licensees. As noted above, a CBRS device, such as a CBSD, needs authorization from the SAS 212 before beginning to transmit in the CBRS band. Even after receiving authorization to transmit in the CBRS band, the SAS 212 may suspend or terminate authorization of one or more of the channels previously authorized by it.

### Current CBRS Systems

One problem that can arise with regard to assigning spectrum in the CBRS network is that the Time Division Duplex (hereafter “TDD”) Configuration that is used by a particular CBSD should be the same across the spectrum. As defined in the CBRS Coexistence Technical Specifications, CBRSA-TS-2001, V 4.0.0, published Apr. 15, 2021 (hereafter the “Coexistence Specifications”), which Coexistence Specifications are hereby incorporated by reference herein as if set forth in full, it is well understood in the industry that a desirable condition for multiple overlapping outdoor LTE-TDD and NR-TDD deployments to coexist in the same band is that they align their frame boundaries and use the same TDD Configuration. Asynchronous operation in the same outdoor area can lead to detrimental interference conditions, and coexistence solutions without alignment of cell phases and TDD Configurations may not be practical and/or efficient.

As used herein, a communication “channel” comprises a radio frequency, or more precisely, a bandwidth allocated on a specific radio frequency. As noted above, a CBRS network specifies 15 (fifteen) communication channels, each channel comprising 10 MHz of bandwidth, wherein the CBRS network uses 150 MHz of bandwidth spectrum, starting from 3.55 GHz and extending to 3.7 GHz. The present methods and apparatus are directed toward managing the bandwidth spectrum allocation and the TDD channel configuration on each of the CBRS channels. As noted above, cross-channel interference can occur based upon the TDD channel configuration that is selected within the CBRS network between adjoining channels within the CBRS network. It is typically estimated that a given channel can cause interference within 40 MHz of its frequency operation in adjoining channels. However, based upon real-world data, it appears that, in use, the neighboring channels are not as negatively impacted by a single frequency's choice of TDD configuration.

FIG. 4 is a simplified illustration of a system that can be used, in some embodiments, to implement an Enterprise wireless network. In one embodiment, the system 400 is part of an Enterprise network (i.e., a private communications network). Authorized UEs 102 can connect wirelessly to an access point or base station (BS/AP) 103b of the Enterprise network implemented by the system 400. In some embodiments, the BS/AP 103b is an eNodeB of an LTE/5G network, a Citizens Broadband Radio Service Device (CBSD) of a Citizens Broadband Radio Service (CBRS), access node of a local area network (LAN) or Wide Area Network (WAN), etc. It should be understood that these are just some of the very large number of communication components that might be serviced/used in the private network implemented by the system 400. Each of the UEs 102 has a transceiver that allows the device to communicate wirelessly with the BS/AP (103b in FIGS. 3 and 304 in FIG. 4). The BS/AP 103b (FIG. 2), 304 (FIG. 3) allows such communication to be extended to resources either within the private network implemented by the system 400 or with resources that are available in other networks, such as the internet, for example, through a gateway (not shown).

In some embodiments, the BS/AP comprises a CBSD within a CBRS. In other embodiments, the BS/AP 103b is an access point, access node, eNodeB or base station operating at a frequency and in conformance with a protocol other than that of the CBRS. Accordingly, the BS/AP may comprise a base station or central wireless communication hub within any wireless communication system. For the sake of describing the disclosed method and apparatus generally, the term BS/AP is used for all such communication nodes. In any case, in some embodiments, the BS/AP generally has a physical layer module (“PHY”) 306 (FIG. 4) and a Medium Access Control sub-layer module (“BS/AP MAC 308” (FIG. 4)). The PHY 306 performs functions associated with the PHY layer of the conventional 7-layer Open Systems Interconnect (OSI) model. The MAC 308 performs functions associated with the MAC sub-layer of a data link layer (“DLL”) of the OSI model.

In such embodiments, the PHY 306 is generally responsible for generating a transmission signal, propagating the signal and for receiving signals. The MAC 308 is generally responsible for receiving content received by the PHY and controlling the physical hardware of the PHY 306. In particular, the MAC 308 determines the assignments of channels, the general organization of the signals to be transmitted, etc. In some cases, the MAC 306 may receive indications as to which channel to assign for transmission of a particular packet of content. However, the MAC determines the particular frequency used to transmit on that channel.

A server 310 (which may also be referred to as an “edge compute platform”) is coupled to the BS/AP 304 over a separate connection from the wireless connection used for communication between the BS/AP 304 and the UEs 102. In some embodiments, the server 310 is coupled by a hardwire connection to the BS/AP 304, such as by a proprietary interface or over a standard interface, such as TR-069 on coaxial cable, ethernet cable, etc. In some embodiments, the BS/AP 304 is mounted on the ceiling within a facility, such as a room within an office building or a factory floor within a manufacturing facility. However, the particular environment in which the private network implemented by the system 300 is installed is not of particular relevance to the disclosed method and apparatus, but is provided merely as context to facilitate an understanding of the disclosed method and apparatus.

In some embodiments, MAC functionality can be distributed between the BS/AP MAC 308 and a server MAC 312 that resides within the server 310. In other embodiments, all of the MAC functionality may be implemented by the server 310. In some embodiments, an Interference Mitigation Unit (IMU) 314 resides within the server 310. The IMU 314 performs functions that lie outside the scope of the conventional functions performed by a conventional MAC and PHY. In some embodiments, the server 310 further comprises a Packet Core Unit (PCU) 315. In some such embodiments, the PCU 315 performs functions similar to those performed by an Evolved Packet Core (EPC) of a 4G LTE network or a 5G Core (5GC) of a 5G network.

In some embodiments, a Service Orchestrator (SO) 316 provides additional functionality. In some such embodiments, the SO 316 comprises one or more of the following units: (1) a Network Operations Unit 318; (2) a Subscriber Management Unit 320; (3) an Analytics & Insights Unit 322; and (4) an Application Intelligence Unit 324. As shown in FIG. 4, the Service Orchestrator 316 communicates with the SAS block.

Restrictions in Current SAS Functionality in Current System Designs

Disadvantageously, the SAS 212 has restrictions in terms of the information that can be shared across Enterprise deployments. The SAS (such as, for example, the SAS 212) cannot share ESC information even across SASs. Also, the SAS does not have the actual channel related information across all of the wireless network deployments in the region and rather is more based on assumed propagation models built into the assessment. This implies that deployments will have to make spectrum, TDD configuration, and power levels of use based on the restricted input provided from the SAS 212.

For the SAS 212 to make changes to the different deployments in a given neighborhood, it will need to run extensive computations requiring significant turn-around time and delays to enforce the changes. Some of this stems from relying on a central node to perform the functions. Additionally, the central node is also not a single entity, but divided amongst different SAS vendors with syncs amongst the various SASs performed only once a day. A given deployment is unable to determine the optimal operating conditions and also cannot adapt the behaviors based on dynamic changes in the needs of the networks within a given neighborhood. Given the computation complexity, the SAS entities 212 are unable to determine and provide appropriate power allocation for a given neighborhood cell. This issue stems more from using a central entity to perform this function.

Additionally, based on the restrictions (legal and computational) present in the SAS 212, the SAS is unable to share sufficient information of the neighborhood for the individual deployments to make intelligent decisions for efficient operation.

In addition, a typical SON algorithm runs a graph algorithm and provides uniform BW allocation and TDD configuration. Also, the allocation remains static within the network. This has the following disadvantages: (1) specific CBSDs where higher capacity cannot be easily accommodated without overprovisioning the full network; (2) the deployment does not adapt to changing capacity requirements at different times to different parts of the network; and (3) accommodating different downlink (DL) and uplink (UL) capacity needs at different parts of the network is difficult.

Accordingly, it would be advantageous to provide a system that contains a “local region” or “coordination zone” that supports a set of enterprise deployments each with a group of CBSDs that together constitute a set of interacting nodes. The present methods and apparatus for peer network communication in wireless networks provides such a system.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 is an illustration of a basic configuration for a wireless communication network, such as a “4G LTE” (fourth generation Long-Term Evolution) or “5G NR” (fifth generation New Radio) network.

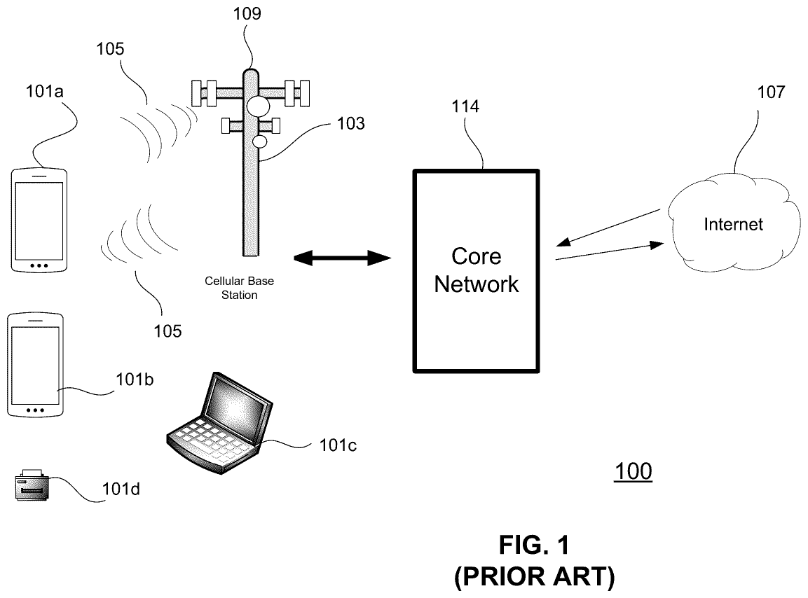

FIG. 2 is an illustration wireless network such as a 5G cellular network operated by a Mobile Network Operator (MNO), sometimes referred to as a wireless service provider, wherein the larger wireless network includes an Enterprise wireless network within the geographic operating area of the MNO network.

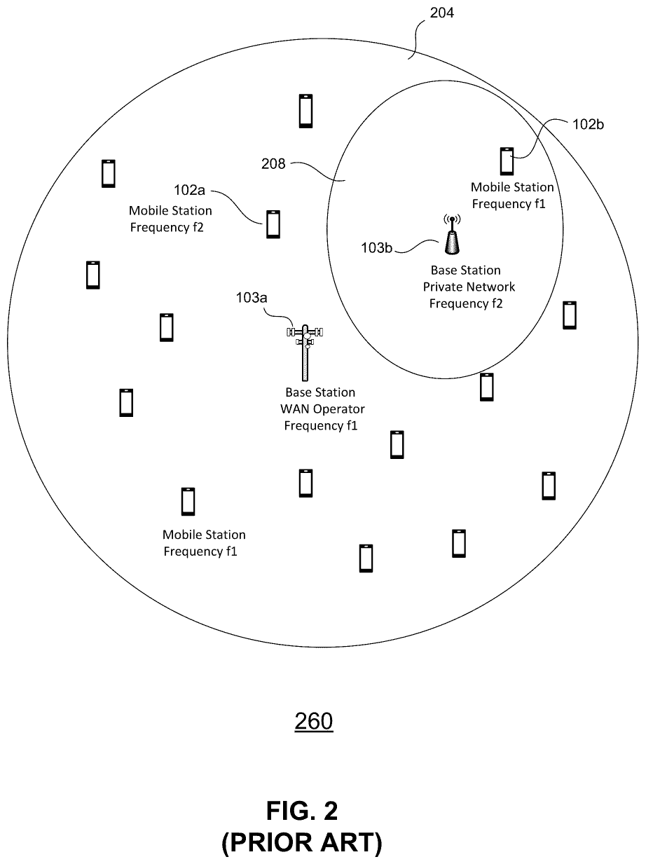

FIG. 3 is a diagram of a wireless communication network that may be implemented as an Enterprise Network using a CBRS network.

FIG. 4 is a simplified illustration of an apparatus used in implementing Enterprise networks (i.e., a private communications network).

FIG. 5 shows a simplified block diagram of an apparatus comprising a centralized CSAS (SAS and CxM), in communication with a Domain Proxy, which in turn both are in communication with a plurality of CBSDs.

FIG. 6 illustrates several use cases for the presently disclosed methods and apparatus for peer network communication in wireless networks in accordance with the present disclosure.

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

The present methods and apparatus for peer network coordination in wireless networks that include a coordination zone or local region that supports a set of enterprise deployments, each having a group of CBSDs that together constitute a set of interacting nodes. This coordination zone will typically comprise one or more connected sets as defined by the OnGo TS-2001 specification.

This also defines a group of deployments in a local region that are willing to interact with each other to establish a mutually aggregable set of operating parameters for each of their networks. These entities share information that enables distributed computation and sharing of results and settle on network operating parameters amongst themselves.

A mutually aggregable central entity that supports the required computation only for a given coordination zone can also be employed in lieu of a distributed compute and subsequent reconciliation approach. This central entity can be the SAS as well with the individual deployments indicating to the SAS that it is willing to share its network deployment information with other entities in the coordination zone that are also willing to share their network deployment information.

### Inter-Deployment Communication

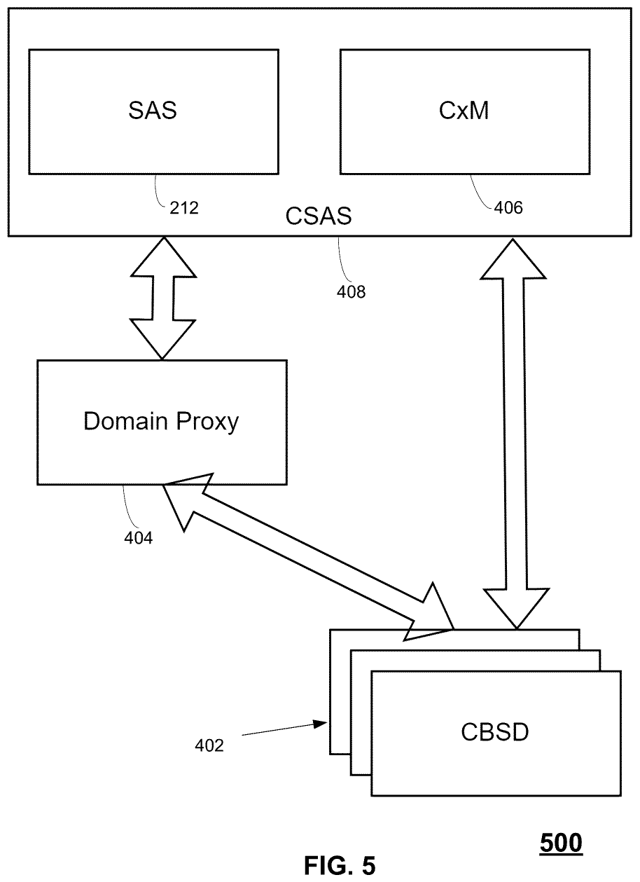

Current communication and resolution of interference and co-existence aspects are performed with the SAS and CxM acting as central entities. These entities are shown in FIG. 5 as a combination of the SAS 212 and CxM 406 into a central CSAS 408 block. The resolution of interference and co-existence with other Enterprise networks requires a lot of information sharing and also there are legal aspects of the extent to which the SAS can communicate back information about the neighboring networks.

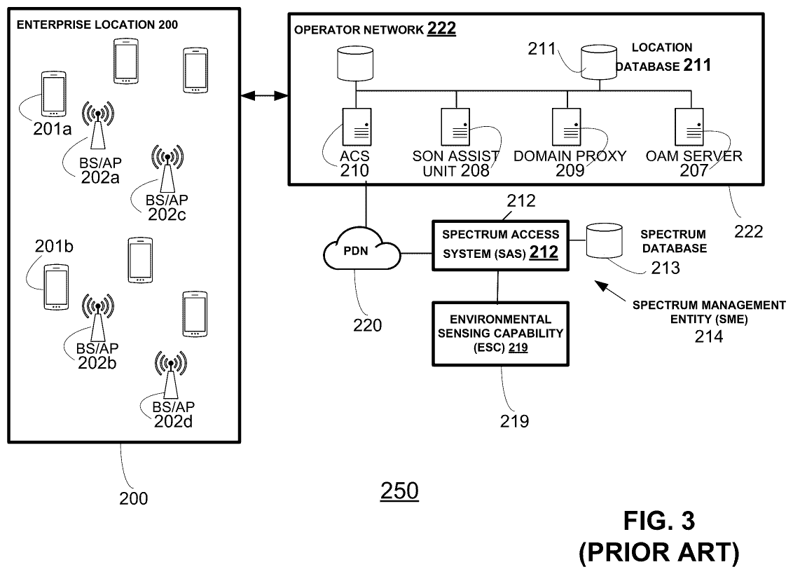

As shown in FIG. 5, in some exemplary embodiments, the apparatus 500 comprises a plurality of CBSDs 402, wherein the plurality of CBSDs 402 are in communication with a Domain Proxy (DP) 404, which, in turn, is in communication with a “CSAS” 408. In some embodiments, as shown in FIG. 5, the CSAS 408 comprises an SAS 212 (such as the SAS 212 shown in FIG. 3 and described in detail hereinabove) and a Coexistence Manager (CxM) 406. In addition to performing other functions, the SAS 212 manages the wireless communications of devices transmitting in the CBRS band, to prevent harmful interference to higher priority (i.e., higher tiered) users. A selected CBRS device (such as a selected CBSD of the plurality of CBSDs 402) requires authorization from the SAS 212 before it can begin to transmit in the CBRS band controlled by the CSAS 408. The Domain Proxy (DP) 404 is an entity engaging in communications with the SAS 212 or CSAS 408 on behalf of the plurality of CBSDs 402 (or networks of CBSDs 402). The Domain Proxy 404 provides a translational capability to interface legacy radio equipment in the 3650-3700 MHz CBRS band with a SAS 212 and thereby ensures compliance with the above-incorporated Part 96 rules.

The Coexistence Manager (CxM) 406 is responsible for assigning a pool of available CBRS spectrum, received from the CSAS 408 for the plurality of CBSDs 402 in a given TCCS. The SAS 212 TDD Configuration Connected Sets (TCCS) are determined by the SAS (such as the SAS 212 of FIG. 3), and more accurately, by the CSAS 408 (FIG. 5) comprising both the SAS 212 and the CxM 406 as shown in FIG. 5.

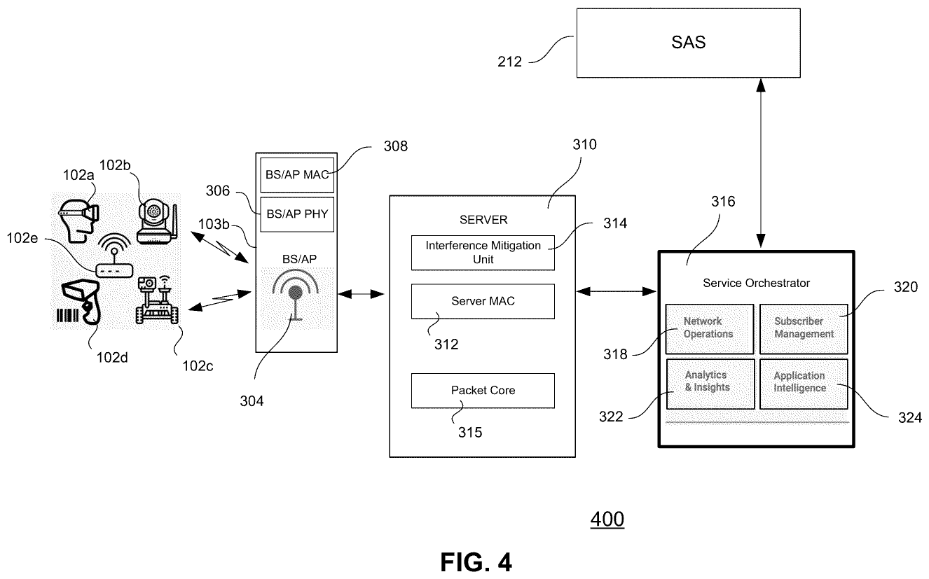

In accordance with the Coexistence Specifications, the CSAS 408 is responsible for providing the Coexistence Group (CxG) of CBSDs (such as the plurality of CBSDs 402 of FIG. 4) with a frequency spectrum assignment that is meant to be distributed among the plurality of CBSDs 402. In particular, the CSAS 408 shall identify one or more sets of CBSDs within the plurality of CBSDs 402 and shall provide the CxM 406 with a spectrum assignment for each set. The CxM 406 performs primary channel assignment consistent with the operation of the CBSDs 402. The CxM 406 is responsible for informing the serving CSAS 408 regarding the GAA Channel Assignments. Coordination of CBRS spectrum use between the plurality of CBSDs 402 is facilitated by exchanging information between the CBSDs 402 belonging to the same TCCS and the CxM 406.

When two adjoining networks are willing to directly interact with each other, it allows for improved co-existence operations. It is possible that the adjoining networks are deployed by the same vendor although the deployments are intended for independent customers/enterprises. Even if deployed by independent vendors, with the enterprise willingly to share information for an improved operations across the two networks, the Domain Proxies of the two networks can be utilized and interaction points to exchange relevant information.

In some embodiments of the presently disclosed methods and apparatus for peer network communication in wireless networks the interface/interaction between the networks can be established (a) between CBSDs 402/domain-proxies 404 operating across deployments for distributed network parameter determination and alignment, and/or (b) with a central entity or “node” acting as a conduit. This central node manages a selected coordination zone and may also help determine the network operational parameters.

In some embodiments, the only information provided to the CSAS 408 is the information that is exchanged between the two networks. In additional, the information also includes information on PCI, channel, power level, current demand for traffic, DL (Downlink) centric versus UL (Uplink) centric, etc.

Network Attributes Coordinated Across Deployments in a Coordination Zone

For a given implementation or embodiment, a potential set of network operating parameters can be arbitered across the entities in a selected coordination zone. This set may include, but is not limited to the following operating parameters:
PCI
Power levels
Channels used along the adjacent CBSDs associated with two different deployments
TDD configuration used
Interference detected
Power backoff request

### Network Deployment Information Shared Across Entities in a Coordination Zone

In some embodiments of the presently disclosed methods and apparatus for peer network communication in wireless networks, a set of network operational parameters are shared across the entities present in the coordination zone. In some embodiments, the set of operational parameters shared across the entities include, but are not limited to the following:
TDD configuration alignment;
Usage based sharing of resources when one deployment is willing to give up resources and earn credits that can be claimed at a later time;
Layering of power levels (inside the ICG versus edge nodes of ICG). This layering of power levels is communicated to the SAS 212 as part of the power change request;
Alternatively, the delta change in power level both up/down is communicated to the SAS. This is preferable given that the actual power levels and the locations of the neighbor CBSD is not known to a selected CBSD apart from its own network;
Integrate a Rel-16 RIM procedure in the SAS process when a given “victim” cell transmits the reference signal and is received by the CBSD; the CBSD that initiates the RIM RS transmission and the CBSD receiving the RIM RS both communicate the information to SAS 212. This communication from the CBSD also includes the preferred power level settings per the above description;
The SAS 212 acts as an arbiter to ensure that this request for changing of the power is legitimate and follows the commands from the SAS 212.
A CBSD experiencing poor RF requests for the neighboring cell's power to be regulated with SAS 212. The request can be to go up or down for all the cells in the neighborhood.

### Neighbor Interference Management

The CBSDs within ICG are treated similarly to any other neighbor to determine if the power level needs to be adjusted based the request from the CBSD. This procedure subsumes both intra-frequency and inter-frequency aspects and comprises a generic request from a CBSD based on the interference for DL and UL operation experienced by the CBSD (such as one of the plurality of CBSDs 402 of FIG. 5). The IEs sent from the CBSD/DP to SAS 212 potentially include only a subset of the parameters as needed:
The current set channels used by the CBSD(s);
The TDD configuration used by the CBSD(s); and
Power levels desired by the CBSD and its neighbors.
Extensions to allow for partial frequency reuse across the deployments potentially sharing the current resource demand requirements.
   The cell itself can be supported as BWP based spectrum allocation dynamically and the interactions with the neighboring networks. Based on factors and designs being considered, it may be necessary to integrate the changes in spectrum allocation for BWP usage for the different cells into the communications with the neighboring networks.
Employ Rel-16 based RIM procedures to be supported via signaling between the networks. This can be performed using the physical channel transmitting signature or just using protocol signaling with the neighboring networks to manage the interference.

### PCI Management Across Network

Additionally, in some embodiments of the presently disclosed methods and apparatus for peer network communication in wireless network, PCI management across the wireless network involves the following functions to be maintained and performed:
CBSD Reg provides PCI/Channel used by the SAS 212;
The SAS 212 has a DB of PCI on a channel basis;
The SAS 212 provides PCIs that are active on each channel; and
With this information the SON chooses an appropriate PCI for each CBSD of the plurality of CBSDs 402.

### Use Case Based BW/TDD Config/Power Level Allocation

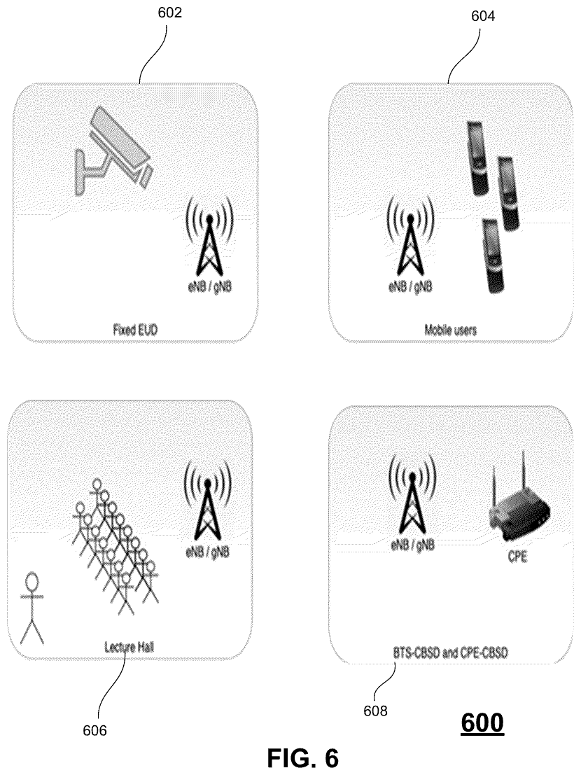

Several illustrative use cases are shown in FIG. 6. For example, use case 602 shows a security camera application. Use case 604 shows a base station or AP in communication with a plurality of UEs. Use case 606 shows a lecture hall application. Use case 608 shows a base station and CPE used in a BTS-CBSD and CPE-CBSD application.

The adaptability of the required resources will depend on the use cases required to be served on an individual cell. Some of it will be permanent such as the security camera application 602 of FIG. 6. CPE connectivity has specific behaviors and will be adaptative based on the number of end-user devices and the active application(s) employed through the CPE. Others can be dependent on the time-of-day/day-of-the-week such as lecture sessions or a conference (see, e.g., use case 606.

### Cognitive Spectrum Sharing—

Information regarding the usage and location of each UE is tracked and collected. This information is based on the {time, AP} that the UE is connected with the added data rate. This data is also used to implement a spectrum allocation control to effectively allocate resources based on the time and UE connected.
1. Each CBSD (such as one of the plurality of CBSDs 402 of FIG. 5) can have multiple grants available;
2. Each CBSD 402 senses the load on it during a certain time period;
3. Based on the load and a static load balancing model on the domain-proxy 404 (see FIG. 5) each CBSD 402 can be given more channels or less channels; and
4. Based on the coverage needed each CBSD 402 can be powered accordingly.

The use cases assist in determining optimal resource allocation. Examples of such use cases include, but are not limited to, the following: (a) a plurality of robots that are congested in a single area; (b) areas in an office where multiple people gather; and (c) a Plant system where one part of the process is more active during a certain time of day. These use cases, and others, will help in saving power consumption.

### CONCLUSION

Methods and apparatus for peer network communication in wireless networks are described. The methods and apparatus make use of a local region or coordination zone that supports a set of Enterprise deployments each including a group of CBSDs that taken together comprise a set of interacting nodes. The group of deployments in a local region are willing to coordinate activities with each other to establish a mutually aggregable set of operating parameters for each of their networks. These entities share information that enables distributed computation and the sharing of results to agree on mutually acceptable network operating parameters.

A mutually aggregable central entity that supports the required computation only for a given coordination zone can also be employed. This central entity can be the SAS as well with the individual deployments indicating to the SAS that it is willing to share its network deployment information with other entities in the coordination zone that are also willing to share their network deployment information.

Although the disclosed method and apparatus is described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A peer network coordination in wireless networks comprising:
a) a coordination zone that supports a set of enterprise deployments, each having a group of CBSDs (Citizens Broadband Radio Service Devices) that together constitute a set of interacting nodes;
wherein the coordination zone comprises one or more connected sets.
